(19) United States
(12) Patent Application Publication
(10) Pub. No.: US 2011/0274180 A1
(43) Pub. Date: Nov. 10, 2011

(54) METHOD AND APPARATUS FOR TRANSMITTING AND RECEIVING LAYERED CODED VIDEO

(75) Inventors: Chang-Hyun LEE, Suwon-si (KR); Min-Woo PARK, Yongin-si (KR); Dae-Sung CHO, Seoul (KR); Dae-Hee KIM, Suwon-si (KR); Woong-Il CHOI, Hwaseong-si (KR)

(73) Assignee: SAMSUNG ELECTRONICS CO., LTD., Suwon-si (KR)

(21) Appl. No.: 13/104,323

(22) Filed: May 10, 2011

Related U.S. Application Data
(60) Provisional application No. 61/333,006, filed on May 10, 2010.

(51) Int. Cl. H04N 7/26

(52) U.S. Cl. 375/240.25; 375/240.29; 375/E07.092; 375/E07.026

(57) ABSTRACT

Transmitting and receiving a layered coded video, in which a picture of a base layer and a picture of at least one enhancement layer are separately encoded, the encoded pictures of the base layer and the encoded pictures of the at least one enhancement layer are arranged on a slice basis, the arranged pictures are packetized by adding a header to the rearranged pictures, and the packets are transmitted as a bit stream.

### CROSS-REFERENCE TO RELATED PATENT APPLICATION

This application claims the benefit of U.S. Provisional Application No. 61/333,006, filed in the U.S. Patent and Trademark Office on May 10, 2010, the contents of which are incorporated herein by reference in their entirety.

### BACKGROUND

1. Field

Exemplary embodiments relate to a video coding method and apparatus, and more particularly, to a method and apparatus for encoding a picture in a layered video coding scheme and decoding the picture.

2. Description of the Related Art

A digital video signal requires processing of a large amount of data. To efficiently transmit a large amount of digital video data in a transmission medium of a limited bandwidth or capacity, video compression is essential. Many video Coder and Decoder (CODEC) techniques have been developed to compress such a large amount of video data.

Most of video CODEC techniques process a video signal on a macroblock-by-macroblock basis. Each macroblock is divided into a plurality of pixel blocks, for processing. Video coding involves motion estimation, motion compensation, Discrete Cosine Transform (DCT), quantization, entropy encoding, etc.

The development of wireless network technology, video CODEC technology, and streaming technology has dramatically widened the application range of Video On Demand (VoD). Users are often seen enjoying services through smart phones as well as Internet Protocol (IP) televisions (IPTVs) at any time in any place. Especially, along with the development of the wireless network technology, Wireless Fidelity (Wi-Fi) has been popular. Now, Wireless Gigabit Alliance (WiGig) is under standardization, aiming at multi-gigabit speed wireless communications in the 60-GHz frequency band. WiGig is one of Wireless Personal Area Network (WPAN) technologies, applicable to fields requiring data traffic of a few to hundreds of gigabits within a short range (e.g. a few meters). For example, WiGig may be used for applications such as using a TV as a display of a set-top like a laptop computer or a game console, or fast download of a video to a smart phone. WiGig can interface between a set-top and a TV. Consumers want to view a variety of multimedia sources on a TV screen to get a feeling of presence from a wider screen. This service will be more attractive if it is easily provided wirelessly, not by cable.

For active wireless interfacing between a set-top and a TV, there are some issues to be tackled. Unlike a wired channel, the available bandwidth of a wireless channel is variable depending on a channel environment. In addition, since data transmission and reception takes place in real time between the set-top and the TV, a receiver suffers a data reception delay unless a transmitter handles the variable bandwidth, that is, the transmitter transmits a reduced amount of data in a suddenly narrowed available bandwidth. Thus a given packet is not processed in view of the real-time feature of data display and thus a broken video may be displayed on the TV screen. To avert this problem, layered coding can be adopted. In layered coding, a video is encoded into a plurality of layers with temporal, spatial, or Signal-to-Noise Ratio (SNR) scalability, to thereby handle various actual transmission environments and terminals.

According to the layered coding scheme, one source including a plurality of layers is generated through a single coding operation. Video data of different sizes and resolutions, such as video data for a Digital Multimedia Broadcasting (DMB) terminal, a smart phone, a Portable Multimedia Player (PMP), and a High Definition TV (HDTV), can be simultaneously supported with the single source. In addition, as the layers are selectively transmitted according to a reception environment, user experiences can be enhanced in a variable network environment. For example, when quality of the reception environment decreases, a picture of a high-resolution layer is converted to a picture of a low-resolution layer, for reproduction. Thus, video interruptions can be overcome. However, there is no conventional specified layered encoding and decoding method supporting low latency in applications demanding real-time processing.

### SUMMARY

An aspect of the exemplary embodiments may address the above problems and/or disadvantages and pmvide the advantages described below.

One or more exemplary embodiments provide a layered video encoding method and apparatus for supporting low-latency transmission.

One or more exemplary embodiments also pmvide a layered video decoding method and apparatus for supporting low-latency transmission.

In accordance with an aspect of an exemplary embodiment, there is provided a method of transmitting a layered coded video in which a picture is divided into a plurality of slices, each slice including a base layer and at least one enhancement layer, the method including encoding a picture of the base layer and encoding a picture of the at least one enhancement layer, arranging the encoded picture of the base layer and the encoded picture of the at least one enhancement layer on a slice basis, packetizing the arranged encoded picture of the base layer and the encoded picture of the at least one enhancement layer by adding a header to the arranged encoded picture of the base layer and the arranged encoded picture of the at least one enhancement layer, and transmitting the packetized pictures as a bit stream.

In accordance with an aspect of another exemplary embodiment, there is provided a method of receiving a layered coded video in which a picture is divided into a plurality of slices, each slice including a base layer and at least one enhancement layer, the method including receiving an encoded bit stream, the encoded bit stream comprising an encoded picture of the base layer and an encoded picture of the at least one enhancement layer arranged on a slice basis, depacketizing the received bit stream, decoding the encoded picture of the base layer and the encoded picture of the at least one enhancement layer on the on the slice basis, and displaying the decoded picture of the base layer and the decoded picture of the at least one enhancement layer.

In accordance with an aspect of another exemplary embodiment, there is provided an apparatus that transmits a layered coded video in which a picture is divided into a plurality of slices, each slice including a base layer and at least one enhancement layer, that includes an encoder that encodes a picture of the base layer and a picture of the at least one enhancement layer and arranges the encoded picture of the base layer and the encoded picture of the at least one enhancement layer on a slice basis, and a transmitter that packetizes the arranged encoded picture of the base layer and the encoded picture of the at least one enhancement layer by adding a header to the arranged encoded picture of the base layer and the arranged encoded picture of the at least one enhancement layer and transmits the packetized pictures as a bit stream.

In accordance with an aspect of another exemplary embodiment, there is provided an apparatus that receives a layered coded video in which a picture is divided into a plurality of slices, each slice including a base layer and at least one enhancement layer, that includes a transmitter that packetizes the arranged encoded picture of the base layer and the encoded picture of the at least one enhancement layer by adding a header to the arranged encoded picture of the base layer and the arranged encoded picture of the at least one enhancement layer and transmits the packetized pictures as a bit stream, a depacketizer that depacketizes the received bit stream, a decoder that decodes the encoded picture of the base layer and the encoded picture of the at least one enhancement layer on the on the slice basis, and a display unit that displays the decoded picture of the base layer and the decoded picture of the at least one enhancement layer.

### BRIEF DESCRIPTION OF THE DRAWINGS

The above and other aspects will be more apparent from the following detailed description taken in conjunction with the accompanying drawings, in which:

FIG. 1 illustrates an example of layered video data;

FIG. 2 is a block diagram of a layered encoding apparatus according to an exemplary embodiment;

FIG. 3 illustrates an example of applying the layered encoding method to a wireless channel environment;

FIG. 4 is a function block diagram defined in the WiGig standard;

FIG. 5 is a block diagram of a system for encoding a bit stream using the layered encoding method and transmitting the encoded bit stream according to an exemplary embodiment;

FIG. 6 illustrates a bit stream output from an application layer, when the bit stream is 3-layered and each picture is divided into four slices in case of using H.264 Advanced Video Coding (AVC) for a base layer CODEC and the layered encoding method for an enhanced layer CODEC;

FIG. 7 illustrates a bit stream arranged on a slice basis at a Protocol Adaptation Layer (PAL);

FIG. 8 is a flowchart illustrating a data transmission operation according to an exemplary embodiment; and

FIG. 9 is a flowchart illustrating a data reception operation according to an exemplary embodiment.

Throughout the drawings, the same drawing reference numerals will be understood to refer to the same elements, features and structures.

### DETAILED DESCRIPTION OF EXEMPLARY EMBODIMENTS

A detailed description of a generally known function and structure will be avoided so as to not obscure the subject matter of the application. The terms described below are defined in connection with the function of the application. The meaning of the terms may vary according to the user, the intention of the operator, usual practice, etc. Therefore, the terms should be defined based on the description rather than the specification.

Necessary processes on a system's part are largely divided into encoding, transmission, reception, decoding, and displaying. If time taken from encoding macro blocks of a predetermined unit to decoding and displaying the macro blocks is defined as latency, time taken to perform each process should be minimized to reduce the latency. In general, when a data image is processed, the data image is encoded at a picture level in a sequential process. Since there is typically one access category, that is, a single queue allocated to video data in the Institute of Electrical and Electronics Engineers (IEEE) 802.11 Medium Access Control (MAC) and PHYsical (PHY) layers, video data of a plurality of layers should be accumulated in the queue, for transmission of the encoded data. Accordingly, when data is packetized, a bit stream of a base layer should be appropriately mixed with a bit stream of an enhancement layer in terms of latency.

In layered coding, however, the increase of latency with the number of enhancement layers does not matter with pixel-level coding because data should be sequentially processed during encoding and decoding due to dependency between a higher layer and a lower layer. This means that the higher layer is not encoded until the lower layer is completely encoded.

The latency of layer coding can be reduced through parallel processing of data. Slice-level coding between layers enables parallel data processing. In addition to the slice-level coding between layers, data transmission and reception and data decoding should be carried out in a pipeline structure.

In a layered coding scheme known as H.264 Scalable Video Coding (SVC), a Network Adaptive Layer (NAL) extension header includes a slice number, dependency_id and a layer number, quality_id in 3 bytes. The fields of dependency_id and quality_id are parameters indicating spatial resolution or Coarse-Grain Scalability (CGS), and Medium-Grain Scalability (MGS), respectively. They impose a constraint on the decoding order of NAL units within an access unit. Due to the constraint, data should be decoded in a sequential process despite slice-level coding. The resulting impaired pipeline structure makes it difficult to reduce latency.

Accordingly, the exemplary embodiments provide a method for encoding and decoding a layered video at a slice level.

Now a description will be given of an encoding and decoding method in a layered video processing technology according to an exemplary embodiment. This exemplary embodiment is applicable, for example, to VC-series video coding proposed by the Society of Motion Picture and Television Engineers (SMPTE). Besides the VC-series video coding, the exemplary embodiment can be applied to any layered video coding or processing technique.

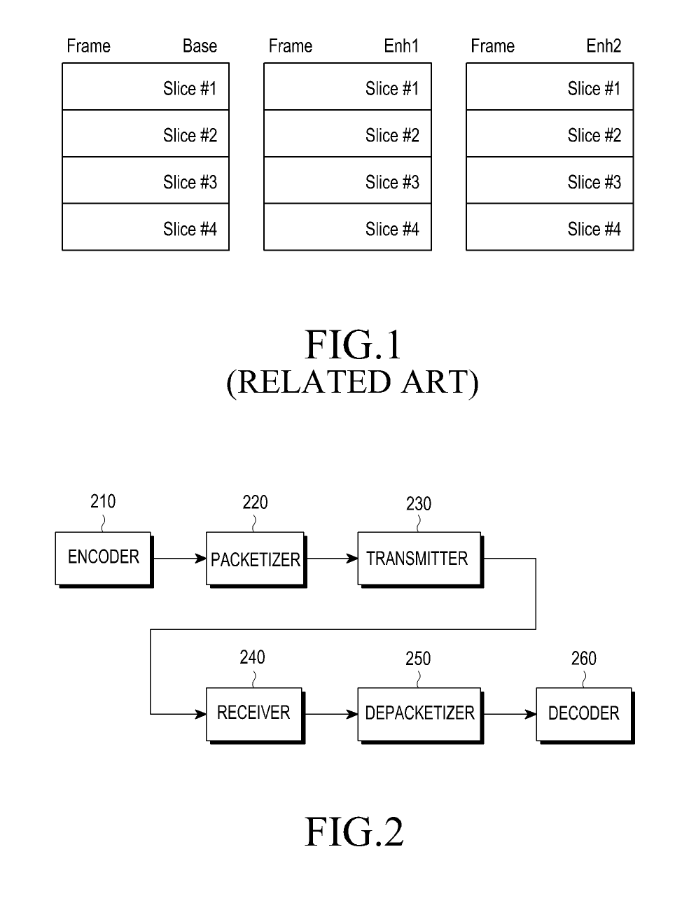

FIG. 1 illustrates an example of layered video data.

A picture includes one base layers and one or more enhancement layers, and a frame of each layer is divided into two or more slices, for parallel processing. Each slice includes a plurality of consecutive macroblocks. In the illustrated case of FIG. 1, a picture includes one base layer (Base) and two enhancement layers (Enh1 and Enh2). In each layer, a frame is divided into four slices, slice #1 to slice #4, for parallel processing.

FIG. 2 is a block diagram of a layered encoding apparatus according to an exemplary embodiment

Referring to FIG. 2, an encoder 210 should support slice-level coding between layers to maintain a pipeline structure of parallel processing. A packetizer 220 packetizes encoded data of a plurality of layers according to the number of physical buffers available to video data at a Medium Access Control (MAC) end. That is, the number of bit streams packetized in the packetizer 220 is equal to the number of physical buffers available to video data at the MAC end. A transmitter 230 transmits the packetized bit streams. A receiver 240 receives the packetized bit streams from the transmitter 230. A depacketizer 250 extracts video data from the received data and depacketizes the video data. A decoder 260 translates slice-level coded data into layer representations according to the layers of the slice-level coded data. To reduce latency, the decoder 260 represents data on a slice basis. Layer representations on a slice basis means that a base layer and enhancement layers are decoded on a slice basis and the decoded layers are represented according to the highest layer.

Since the exemplary embodiment allows slice-level decoding, the service quality of a receiver when an available bandwidth is changed according to a channel environment may be increased. Now a detailed description will be given of an exemplary embodiment of applying the encoding and decoding method of the exemplary embodiment to the WiGig standard.

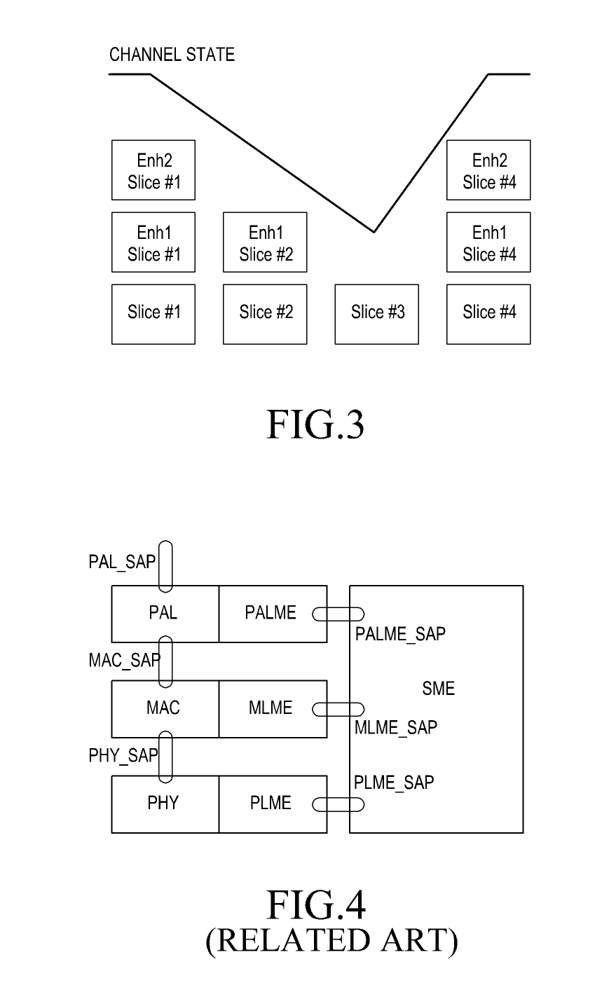

FIG. 3 illustrates an example of applying the layered encoding method to a wireless channel environment.

Referring to FIG. 3, if an available bandwidth is sufficient for transmitting layers due to a good channel state, all of three layers are transmitted. For example, slice #1 and slice #4 are transmitted in the three layers. On the other hand, if the wireless channel state is poor, only layers that the available bandwidth permits are transmitted. Thus, slice #2 and slice #3 are transmitted in two layers and one layer, respectively in FIG. 3.

To transmit a different number of layers according to different channel states, considerations should be taken into account on a system's part including an application layer that performs the layered encoding method, a MAC layer, and a Protocol Adaptation Layer (PAL) that mediates between the MAC layer and the application layer and controls the MAC layer and the application layer.

FIG. 4 is a block diagram defined in the WiGig standard. The WiGig is an independent standardization organization different from the existing Wireless Fidelity Alliance (WFA), seeking to provide multi-gigabit wireless services. To transmit a bit stream according to a wireless channel environment in the layered encoding method, the PAL needs additional functions.

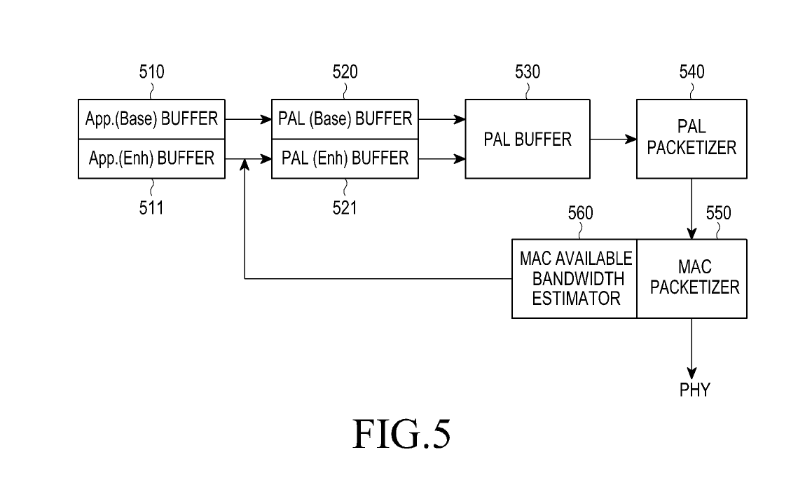

FIG. 5 is a block diagram of a system for encoding a bit stream in the layered encoding method and transmitting the encoded bit stream according to an exemplary embodiment.

Referring to FIG. 5, at the application layer, bit streams are encoded into a base layer and an enhancement layer in the layered encoding method. The coded bit streams of the base layer and the enhancement layer are buffered in two buffers 510 and 511, respectively. At the PAL, the bit streams of the base layer and the bit streams of the enhancement layer are buffered in a base layer buffer 520 and an enhancement layer buffer 521, respectively.

One reason for classifying bit streams into the base layer and the enhancement layer is that it may be difficult to packetize the bit streams of the base layer and the enhancement layer together, due to use of different CODECs for the base layer and the enhancement layer. Another reason is that individual packetizing for the base layer and the enhancement layer shortens the time required to discard data of the enhancement layer according to a wireless channel state.

When the application layer transmits data to the PAL, the data of the enhancement layer is partially discarded according to an available bandwidth. For this purpose, a MAC layer 560 should estimate the available bandwidth and feed back the estimated available bandwidth to the application layer. The available bandwidth may be estimated by comparing the number of packets transmitted by a transmitter with the number of packets received at a receiver and thus estimating the channel state between the transmitter and the receiver. Many other methods can be used to estimate the available bandwidth, which is beyond the scope of the application and thus will not be described in detail herein.

The application layer determines enhancement-layer data to be transmitted to the PAL according to the estimated available bandwidth and deletes the remaining enhancement-layer data in the enhancement layer buffer 521. That is, a video CODEC of the application layer detects an enhancement-layer bit stream to be discarded by parsing packetized bit streams including a ‘starting bytes prefix’ and deletes the detected enhancement-layer bit stream in the buffer. After this operation, base-layer bit streams and enhancement-layer bit streams are buffered in the base layer buffer 520 and the enhancement-layer buffer 521 of the PAL, respectively.

If two or more queues are allocated for video data at a MAC layer in a service system, one queue is allocated to base-layer bit streams and the other queue is allocated to enhancement-layer bit streams. To store a bit stream in a MAC-layer queue, a PAL packetizer 540 constructs a packet by adding a PAL header to the bit stream, and a MAC packetizer 550 packetizes the packet with the PAL header by adding a MAC header to it.

Typically, one queue is allocated to each service flow in the MAC layer. If only one queue is allocated for video data in the MAC layer of the service system and thus divided into two queues for the base layer and the enhancement layer, a PAL buffer 530 needs to combine separately queued bit streams of the base layer and the enhancement layer. Specifically, a base-layer bit stream is followed by an enhancement-layer bit stream on a slice basis and each bit stream is buffered in the PAL buffer 530 by parsing the slice number and layer number of the bit stream.

While the WiGig standard arranges bits streams on a slice basis at the PAL, other systems without the PAL may arrange bit streams in an encoder and then transmit the arranged bit streams to the MAC layer.

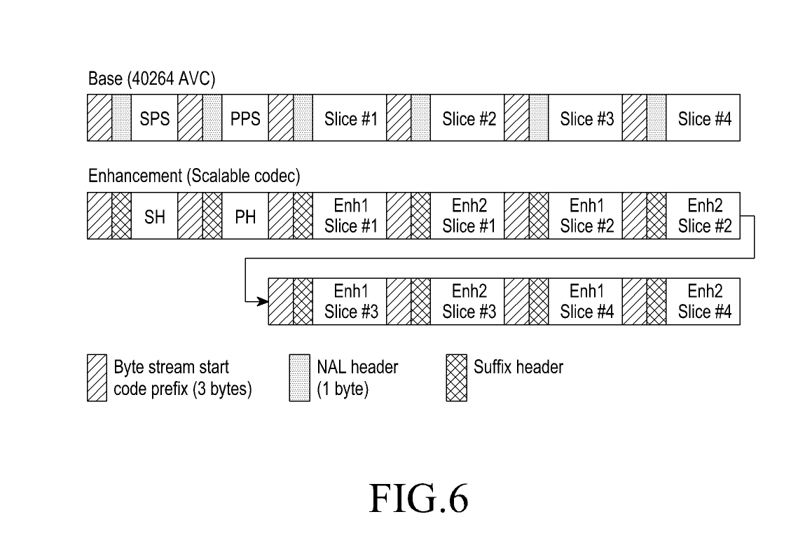

FIG. 6 illustrates a bit stream output from an application layer, when the bit stream is 3-layered and each picture is divided into four slices in case of using H.264 Advanced Video Coding (AVC) for a base layer CODEC and the layered encoding method for an enhanced layer CODEC.

A base-layer bit stream sequentially contains a Byte stream start code prefix, a Network Adaptive Layer (NAL) header, header information known as a Sequence Parameter Set (SPS) and a Picture Parameter Set (PPS), and base-layer data of each slice in this order.

An enhancement-layer bit stream sequentially contains a Byte stream start code prefix, a Suffix header, a Sequence Header (SH), a Picture Header (PH), and enhancement-layer data of each slice in this order. The header information of a layered coded packet, ‘suffix byte’ functions similarly to a NAL byte of H.264.

Data of a second enhancement layer for Slice #2 (Enh2 Slice #2) and data of first and second enhancement layers for Slice #3 (Enh1 Slice #3 and Enh2 Slice #3) are discarded from among enhancement-layer data according to a estimated available bandwidth and the remaining enhancement-layer data is transmitted to the PAL. The PAL arranges the base-layer data and the enhancement-layer data on a slice basis and combines the slicewise arranged base-layer data and enhancement-layer data.

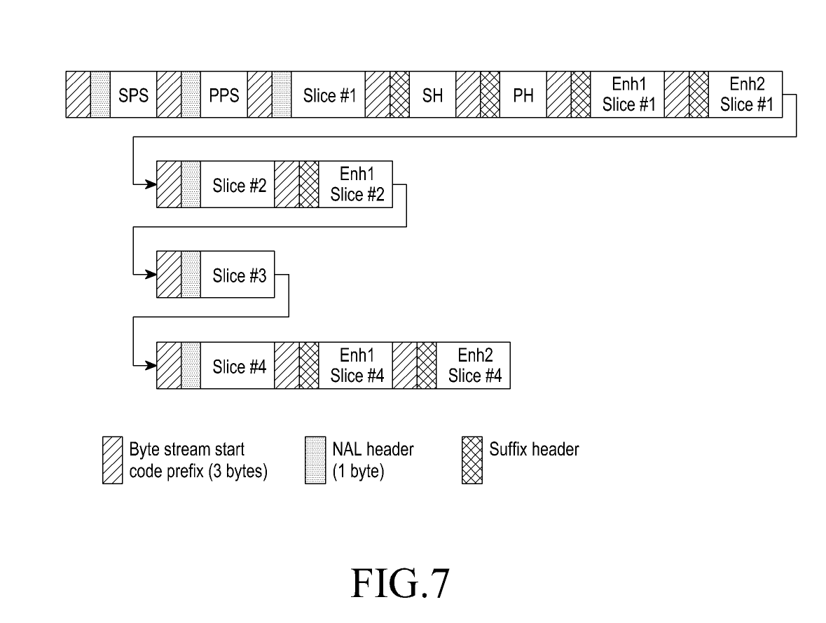

FIG. 7 illustrates a bit stream arranged on a slice basis at the PAL.

Referring to FIG. 7, the header information, SPS and PPS and the first slice data (Slice #1) of the base layer are followed by the header information SH and PH of the first enhancement layer and the first slice data of the first enhancement layer (Enh1 Slice #1), and then followed by the first slice data of the second enhancement layer (Enh2 Slice #1). After Enh2 Slice #1, the base-layer data and first enhancement-layer data of the second slice (Slice #2 and Enh1 Slice #2), the base-layer data of the third slice (Slice #3), and the base-layer data and first- and second-enhancement layer data of the fourth slice (Slice #4, Enh1 Slice #4, and Enh2 Slice #4) are sequentially arranged. Although Enh1 Slice #2 belongs to the first enhancement layer, Enh2 Slice #1 of the second enhancement layer does not need reference to Enh1 Slice #2 of the first enhancement layer and thus Enh2 Slice #1 may precede Enh1 Slice #2.

When receiving the bit stream arranged in the above order, the receiver can decode the bit stream on a slice basis, thereby reducing latency in data processing.

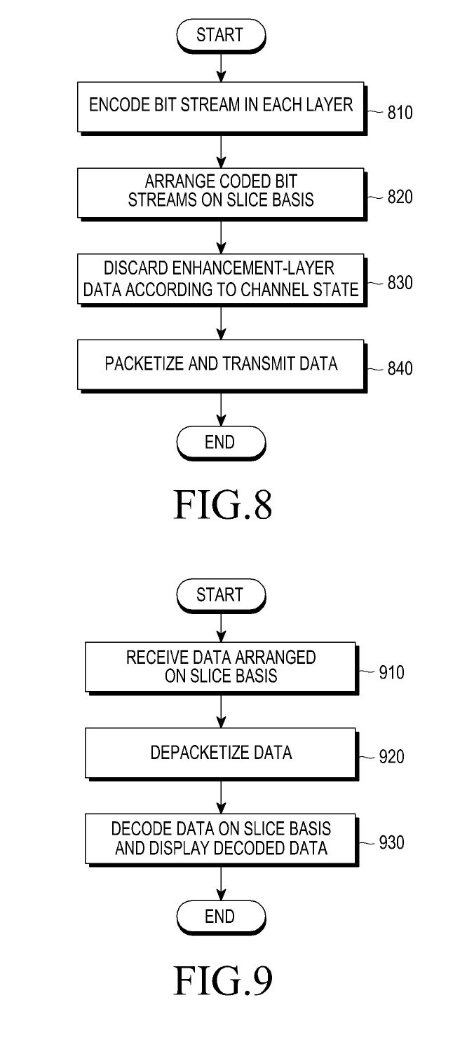

FIG. 8 is a flowchart illustrating a data transmission operation according to an exemplary embodiment.

Referring to FIG. 8, the application layer encodes a multi-layered picture in each of layer (810) and arranges the coded bit streams of the respective layers on a slice basis in step (820). Specifically, if three layers are defined and one picture is divided into four slices, base-layer data of a first slice is followed by first enhancement-layer data of the first slice, second enhancement-layer data of the first slice, and then base-layer data of a second slice. In this manner, up to second-enhancement layer data of the last slice is arranged.

Upon receipt of feedback information about a channel state from the MAC layer, the application layer discards enhancement-layer data of a slice or slices from the arranged data according to the channel state (830) and transmits the base-layer data and the remaining enhancement-layer data to the MAC layer.

The MAC layer then packetizes the received data by adding a MAC header to the received data and transmits the packet to the PHY layer (840).

FIG. 9 is a flowchart illustrating a data reception operation according to an exemplary embodiment.

Referring to FIG. 9, the receiver receives data arranged in slices from the transmitter (910). The receiver extracts a header from the received data, analyzes the header, and then depacketizes the received data (920). The receiver then decodes the depacketized data on a slice basis and displays the decoded data (930). In this manner, the data decoded on a slice basis can be directly displayed. Therefore, latency can be reduced, compared to layer-level decoding.

The encoding and decoding method of the exemplary embodiment is applicable to layered coding applications requiring a low latency or a small buffer size. For instance, for m enhancement layers and one picture being divided into n slices in a parallel processing system, if encoding takes an equal time for the base layer and the enhancement layers, latency is given by equation (1) in case of layered coding in a pipeline structure.

Latencyₚᵣₒ=(1+m/n)*(t_{enc}+t_{dec}) (1)

where tₑₙₑ is a time taken for encoding and t_{dec} is a time taken for decoding.

When layered coding is performed in the pipeline structure as described in equation (1), the latency is reduced to the latency of the base layer as the number of slices in a picture, n increases. That is, the latency is equal to the latency of a single-layer CODEC.

On the other hand, in case of layered coding in a sequential processing system, the latency is computed by

Latency_{con}=(1+m)*(t_{enc}+t_{dec}) (2)

When layered coding is performed in the sequential processing system as described in equation (2), the latency increases in proportion to the number of enhancement layers, m in addition to the latency of the base layer.

The exemplary embodiments can also be embodied as computer readable codes on a computer readable recording medium. The computer readable recording medium is any data storage device that can store data, which can be thereafter read by a computer system to execute the computer readable codes stored thereon.

The exemplary embodiments may be implemented as encoding and decoding apparatuses, for performing the encoding and decoding methods, that include a bus coupled to every unit of the apparatus, a display, at least one processor connected to the bus, and memory connected to the bus to store commands, receive messages, and generate messages, and the processor executes the commands and controls the operations of the apparatuses.

Examples of the computer readable recording medium include read-only memory (ROM), random-access memory (RAM), CD-ROMs, magnetic tapes, floppy disks, and optical data storage devices. The computer readable recording medium can also be distributed over network coupled computer systems so that the computer readable code is stored and executed in a distributed fashion. In an alternative embodiment, the exemplary embodiments can also be embodied as computer readable transmission media, such as carrier waves, for transmission over a network.

While exemplary embodiments been particularly shown and described, it will be understood by those of ordinary skill in the art that various changes in form and details may be made therein without departing from the spirit and scope of the inventive concept as defined by the following claims.

What is claimed is:

1. A method of transmitting a layered coded video in which a picture is divided into a plurality of slices, each slice including a base layer and at least one enhancement layer, the method comprising:
encoding a picture of the base layer and encoding a picture of the at least one enhancement layer;
arranging the encoded picture of the base layer and the encoded picture of the at least one enhancement layer on a slice basis; and
packetizing the arranged encoded picture of the base layer and the encoded picture of the at least one enhancement layer by adding a header to the arranged encoded picture of the base layer and the arranged encoded picture of the at least one enhancement layer; and
transmitting the packetized pictures as a bit stream.

2. The method of claim 1, wherein the arranging comprises arranging in a slice order the encoded picture of the base layer followed by the encoded picture of the at least one enhancement layer in a same slice.

3. The method of claim 2, wherein the arranging further comprises parsing a slice number and a layer number in data of the bit stream.

4. The method of claim 2, further comprising:
estimating an available bandwidth according to a current channel state; and
deleting predetermined data of the at least one enhancement layer of a predetermined slice from the arranged encoded picture of the base layer and encoded picture of the at least one enhancement layer.

5. The method of claim 1, wherein the packetizing comprises packetizing the arranged encoded picture of the base layer and the encoded picture of the at least one enhancement layer according to a number of buffers at a Medium Access Control (MAC) layer.

6. A method of receiving a layered coded video in which a picture is divided into a plurality of slices, each slice including a base layer and at least one enhancement layer, the method comprising:
receiving an encoded bit stream, the encoded bit stream comprising an encoded picture of the base layer and an encoded picture of the at least one enhancement layer arranged on a slice basis;
depacketizing the received bit stream;
decoding the encoded picture of the base layer and the encoded picture of the at least one enhancement layer on the on the slice basis; and
displaying the decoded picture of the base layer and the decoded picture of the at least one enhancement layer.

7. The method of claim 6, wherein the depacketized bit stream is arranged in a slice order in which the encoded picture of the base layer is followed by the encoded picture of the at least one enhancement layer in a same slice.

8. The method of claim 6, wherein data of the depacketized bit stream includes a slice number and a layer number.

9. The method of claim 6, wherein predetermined data of the at least one enhancement layer of a predetermined slice is absent in the received bit stream according to an available bandwidth estimated according to a channel state.

10. An apparatus that transmits a layered coded video in which a picture is divided into a plurality of slices, each slice including a base layer and at least one enhancement layer, the apparatus comprising:
an encoder that encodes a picture of the base layer and a picture of the at least one enhancement layer and arranges the encoded picture of the base layer and the encoded picture of the at least one enhancement layer on a slice basis; and
a transmitter that packetizes the arranged encoded picture of the base layer and the encoded picture of the at least one enhancement layer by adding a header to the arranged encoded picture of the base layer and the arranged encoded picture of the at least one enhancement layer and transmits the packetized pictures as a bit stream.

11. The apparatus of claim 10, wherein the encoder arranges the encoded picture of the base layer and the encoded picture of the at least one enhancement layer in a slice order in which the encoded picture base layer is followed by the encoded picture of the at least one enhancement layer in a same slice.

12. The apparatus of claim 11, wherein the encoder parses a slice number and a layer number in data of the bit stream.

13. The apparatus of claim 11, further comprising an estimator that estimates an available bandwidth according to a current channel state,
wherein the encoder deletes predetermined data of the at least one enhancement layer of a predetermined slice from the arranged encoded picture of the base layer and encoded picture of the at least one enhancement layer.

14. The apparatus of claim 10, wherein the transmitter packetizes the arranged encoded picture of the base layer and the encoded picture of the at least one enhancement layer according to a number of buffers at a Medium Access Control (MAC) layer.

15. An apparatus that receives a layered coded video in which a picture is divided into a plurality of slices, each slice including a base layer and at least one enhancement layer, the apparatus comprising:
a receiver that receives an encoded bit stream, the encoded bit stream comprising an encoded picture of the base layer and an encoded picture of the at least one enhancement layer arranged on a slice basis;
a depacketizer that depacketizes the received bit stream;
a decoder that decodes the encoded picture of the base layer and the encoded picture of the at least one enhancement layer on the on the slice basis; and
a display unit that displays the decoded picture of the base layer and the decoded picture of the at least one enhancement layer.

16. The apparatus of claim 15, wherein the depacketized bit stream is arranged in a slice order in which of the encoded picture of the base layer is followed by the encoded picture of the at least one enhancement layer in a same slice.

17. The apparatus of claim 15, wherein data of the depacketized bit stream includes a slice number and a layer number.

18. The apparatus of claim 15, wherein predetermined data of the at least one enhancement layer of a predetermined slice is absent in the received bit stream according to an available bandwidth estimated according to a channel state.

19. A method of encoding a layered video in which a picture is divided into a plurality of slices, each slice including a base layer and at least one enhancement layer, the method comprising:
encoding a picture of the base layer and encoding a picture of the at least one enhancement layer;
arranging the encoded picture of the base layer and the encoded picture of the at least one enhancement layer on a slice basis; and
outputting the arranged encoded picture of the base layer and the encoded picture of the at least one enhancement layer in a bit stream.

20. The method of claim 19, wherein the arranging comprises arranging in a slice order in which the encoded picture of the base layer followed by the encoded picture of the at least one enhancement layer in a same slice.

21. The method of claim 20, wherein the arranging further comprises parsing a slice number and a layer number in data of the bit stream.

22. A method of decoding a layered coded video in which one picture is divided into a plurality of slices, each slice including a base layer and at least one enhancement layer, the method comprising:
receiving an encoded bit stream, the encoded bit stream comprising an encoded picture of the base layer and an encoded picture of the at least one enhancement layer arranged on a slice basis; and
decoding the encoded picture of the base layer and the encoded picture of the at least one enhancement layer on the on the slice basis.

23. The method of claim 22, wherein the encoded bit stream is arranged in a slice order in which the encoded picture of the base layer is followed by the encoded picture of the at least one enhancement layer in a same slice.

24. The method of claim 22, wherein data of the encoded bit stream includes a slice number and a layer number.

25. An apparatus that encodes a layered video in which a picture is divided into a plurality of slices, each slice including a base layer and at least one enhancement layer, the apparatus comprising:
an encoder that encodes a picture of the base layer and a picture of the at least one enhancement layer; and
an arranger that arranges the encoded picture of the base layer and the encoded picture of the at least one enhancement layer on a slice basis; and
an output unit that outputs the arranged encoded picture of the base layer and the encoded picture of the at least one enhancement layer in a bit stream.

26. The apparatus of claim 25, wherein the arranger arranges the encoded picture of the base layer and the encoded picture of the at least one enhancement layer in a slice order in which the encoded picture of the base layer followed by the encoded picture of the at least one enhancement layer in a same slice.

27. An apparatus that decodes a layered coded video in which a picture is divided into a plurality of slices, each slice including a base layer and at least one enhancement layer, the apparatus comprising:
a receiver that receives an encoded bit stream, the encoded bit stream comprising an encoded picture of the base layer and an encoded picture of the at least one enhancement layer arranged on a slice basis; and
a decoder that decodes the encoded picture of the base layer and the encoded picture of the at least one enhancement layer on the on the slice basis.

28. The apparatus of claim 27, wherein the encoded bit stream is arranged in a slice order in which the encoded picture of the base layer is followed by the encoded picture of the at least one enhancement layer in a same slice.

29. The apparatus of claim 27, wherein data of the encoded bit stream includes a slice number and a layer number.
